(19) United States
(12) Patent Application Publication
(10) Pub. No.: US 2013/0245915 A1
(43) Pub. Date: Sep. 19, 2013

(54) METHOD FOR DETERMINING A CYLINDER CHARGE OF AN INTERNAL COMBUSTION ENGINE

(71) Applicant: Andre F. CASAL KULZER, Boeblingen (DE)

(72) Inventor: Andre F. CASAL KULZER, Boeblingen (DE)

(73) Assignee: Robert Bosch GmbH, Stuttgart (DE)

(21) Appl. No.: 13/798,332

(22) Filed: Mar. 13, 2013

(30) Foreign Application Priority Data
Mar. 13, 2012 (DE) 10 2012 203 876.0

(51) Int. Cl. F02D 9/00

(52) U.S. Cl. CPC F02D 9/00
USPC 701/102

(57) ABSTRACT

A method is described for determining a cylinder charge of an internal combustion engine by using a model. The rotational speed of the internal combustion engine, its intake manifold pressure, its intake manifold temperature, its exhaust gas mass flow, its external exhaust gas recirculation, a starting variable of a model for internal residual gas determination, a valve control time, a valve lift, as well as a variable for the characteristic curve of an operating mode switchover of the internal combustion engine are used as input variables of model.

### CROSS REFERENCE

The present application claims the benefit under 35 U.S.C. §119 of German Patent Application No. DE 102012203876.0, filed on Mar. 13, 2012, which is expressly incorporated herein by reference in its entirety.

### FIELD

The present invention relates to a method for determining a cylinder charge of an internal combustion engine, in particular a gasoline engine having a gasoline direct injection and a partially variable valve operation.

Furthermore, the present invention relates to a computer program which executes all steps of the method according to the present invention, when it runs on an arithmetic unit, and a data medium which stores this computer program. Finally, the present invention relates to a control unit which is designed to carry out the method according to the present invention.

### BACKGROUND INFORMATION

When operating an internal combustion engine in the HCCI (homogenous charge compression ignition) mode, which is sometimes also referred to as CAI (controlled auto-ignition), ATAC (active thermo-atmosphere combustion), or TS (Toyota Soken), the ignition of the air/fuel mixture does not take place via spark ignition (SI), but rather via controlled auto-ignition. The HCCI combustion process may, for example, be caused by a high content of hot residual gases and/or by a high compression and/or by a high intake air temperature. The precondition for the auto-ignition is a sufficiently high energy level in the cylinder. Internal combustion engines which are operable in the HCCI mode and which may be both gasoline and diesel engines are, for example, described in U.S. Pat. Nos. 6,260,520, U.S. Pat. No. 6,390,054, German Patent No. DE 199 27 479 and PCT Application No. WO 98/10179.

The HCCI combustion has the advantage over a conventional spark-ignited combustion that the fuel consumption and the pollutant emissions are reduced. However, it is not easy to regulate the combustion process and, in particular, to control the auto-ignition of the mixture. It is thus necessary to control the manipulated variables which influence the combustion process, e.g., the fuel injection (injection quantity or injection timing and duration), the internal or external exhaust gas recirculation, the inlet valves and the exhaust valves (variable valve control), the exhaust-gas back pressure (exhaust-gas flap), a spark assistance, if necessary, the air intake temperature, the fuel quality, and the compression ratio (in internal combustion engines having a variable compression ratio).

In conjunction with auto-ignition combustion processes, the control/regulation of the auto-ignition as well as the engine characteristic map range, in which this combustion process may be used, play a crucial role. Moreover, it is necessary to be able to switch over rapidly and in a torque neutral way between the spark ignition and auto-ignition operating modes, since the auto-ignition may be operated for low load ranges and it must be switched over to spark ignition for higher loads. New homogenous combustion processes for gasoline engines (gasoline auto-ignition) may only be used within a limited engine characteristic map range and at a very well defined thermodynamic state of the cylinder charge, high temperatures being necessary due to the high degree of exhaust gas recirculation, exhaust gas back suction, exhaust gas upstream position, or exhaust gas retention.

German Patent Application No. DE 10 2006 033 024 A1 describes a method which prevents misfires or premature or late auto-ignitions in the case of a load change of the internal combustion engine or at least reduces their frequency. For this purpose, the operating parameters of the starting operating mode are adapted to the values required for the target operating mode during a pilot control phase, the operating mode is switched over after the pilot control phase, and the operating parameters are regulated after the switchover, when there is a transition of an internal combustion engine from a starting operating mode to a target operating mode, the starting operating mode and the target operating mode being either a spark ignition operating mode or an auto-ignition operating mode. A misfire-free and quiet pilot control and regulation of such an operating mode switchover is indispensable. The quality and robustness of the operating mode switchover is, however, reduced when the cylinder charge of the internal combustion engine is not known.

### SUMMARY

In an example method according to the present invention for determining an intake manifold charge of an internal combustion engine, the rotational speed of the internal combustion engine, its intake manifold pressure, its intake manifold temperature, its exhaust gas mass flow, its external exhaust gas recirculation, a starting variable of a model for internal residual gas determination, a valve control time, a valve lift, as well as a variable for the characteristic curve of an operating mode switchover of the internal combustion engine are used as the input variables of the model. This model is used to determine the intake manifold charge. In accordance with the present invention, cylinder charge is understood as the sum of air mass and residual gas in every cylinder of the internal combustion engine. The example method according to the present invention allows the determination of the charge present in every cylinder at every point in time or combustion cycle.

The cylinder charge may be particularly important for the implementation of the quality and robustness of an operating mode switchover, since in particular when switching over between different intake manifold pressure states, i.e., in the dethrottled or in the throttled state, there is a very high dynamic in the intake manifold pressure. In this case, the instantaneous cycle-individual charge must be determined. For this purpose, the method according to the present invention is used, in particular, for an operating mode switchover, which takes place from a starting operating mode to a target operating mode; the starting operating mode and the target operating mode are either a spark ignition operating mode or an auto-ignition operating mode, and the operating parameters of the starting operating mode are adapted to the values required for the target operating mode during a pilot control phase, the operating mode is switched over after the pilot control phase, and the operating parameters are regulated.

According to an example embodiment of the present invention, a variable for the characteristic curve of the operating mode switchover is understood as a variable which characterizes the characteristic curve over time of an operating mode switchover, in particular with regard to an opening behavior of a gas exchange valve. In accordance with the present invention, it is preferred that the variable for the characteristic curve of the operating mode switchover is selected from the group including an operating time, a cycle number, and an input from a switchover strategy. The input from a switchover strategy may be an input for a valve control, for example.

The model is preferably an empirical charge model or a physical charge model. This model may be considered in the control of the internal combustion engine.

The cylinder charge in the combustion chamber of each individual combustion cycle of the internal combustion engine is preferably determined. This information allows the fuel mass and the injection timing of each individual combustion cycle to be output in a manner adapted to the mixture formation requirements.

The example method according to the present invention may be implemented in the engine control unit of an internal combustion engine with the aid of the example computer program according to the present invention. It is stored, for this purpose, on the data medium according to the example embodiment of the present invention. An example control unit according to the present invention is used to operate an internal combustion engine, while carrying out the example method according to the present invention.

### BRIEF DESCRIPTION OF THE DRAWINGS

One exemplary embodiment of the present invention is shown in the figures and explained in greater detail below.

FIG. 1 shows the change of the throttle valve angle and the intake manifold pressure of an internal combustion engine during a switchover strategy from a throttled spark ignition to a gasoline auto-ignition operation.

FIG. 2 shows the change of the throttle valve angle and the intake manifold pressure of an internal combustion engine during a switchover strategy from a gasoline auto-ignition operation to a throttled spark ignition.

FIG. 3 shows a schematic representation of a method according to one specific embodiment of the present invention.

### DETAILED DESCRIPTION OF EXAMPLE EMBODIMENTS

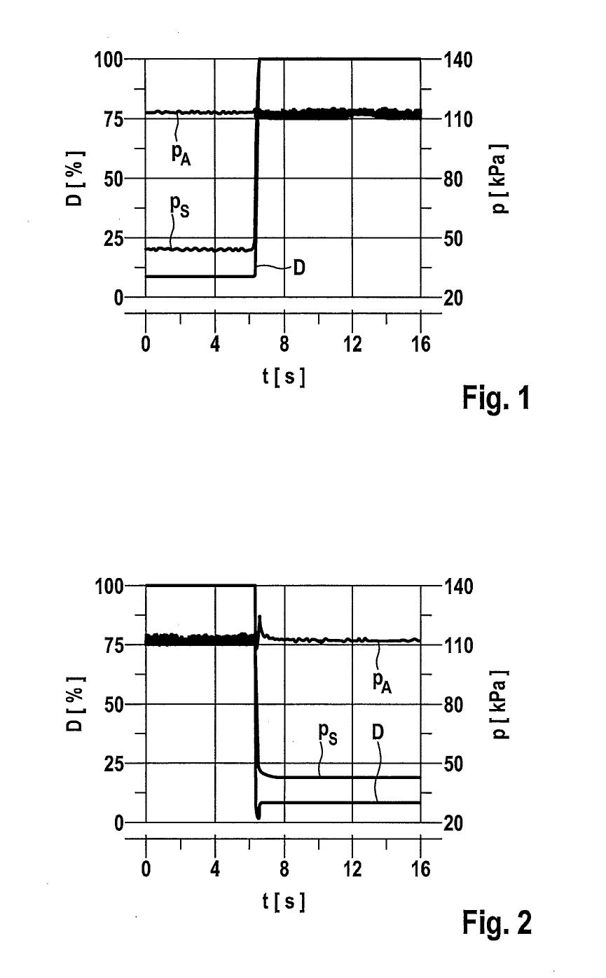

During the transition of an internal combustion engine from a spark ignition operation to an auto-ignition operation (SI to HCCI), a higher exhaust gas temperature or exhaust gas enthalpy is generated during the spark ignition operation. For the switchover process, this means that less residual gas is initially retained or recirculated during a short transition phase in order to set the desirable temperature or enthalpy for the auto-ignition. The residual gas quantity needed for the auto-ignition may be recirculated via a variable valve operation and/or via an external exhaust gas recirculation (EGR) which may be conditioned. In addition to a defined increase in the residual gas quantity, the throttle valve must open simultaneously in a controlled or regulated manner during the transition phase so that the necessary air quantity enters the cylinder. In order to make the transition as torque-neutral as possible, the charge and the injection timing must be regulated in a targeted manner to achieve the desirable auto-ignition timing. During the auto-ignition operation, the load is basically set via the injected fuel mass, while the combustion position is regulated by a mixture between the residual gas and the fresh air mass, the mixture being set in a targeted manner, and via the injection timing. For the switchover, a combination of pilot control and cycle-synchronous control thus takes place. FIG. 1 shows how pressure pₛ in the intake manifold of the internal combustion engine rises with increasing throttle angle D (indicated in percent of the throttle valve opening) up to an angle of 100% (throttle valve completely open) at the switchover point in time, while exhaust gas pressure p_{A} remains constant. During the switchover, a high dynamic is recognizable in intake manifold pressure pₛ.

During the transition from the gasoline auto-ignition operation to the spark ignition operation (HCCI to SI), it should be noted that a lower exhaust gas temperature is generated during the auto-ignition operation. This may result in higher emissions during the switchover. For this reason, an optimal mixture formation is necessary during this phase. During the switchover, the residual gas portion in the cylinder is minimized via a variable valve operation, for example, and/or via an external exhaust gas recirculation (EGR), to stabilize the spark ignition combustion. Here, the throttle valve must close simultaneously in a regulated manner so that only the necessary air quantity enters the cylinder. In addition to the charge, the ignition and the injection timings must be regulated in a targeted manner to generate the desirable torque. Here, too, a combination of pilot control and cycle-synchronous control is advantageous. FIG. 2 shows the change in intake manifold pressure pₛ of the internal combustion engine when the throttle valve is closing. At the switchover point in time, a very rapid reduction of intake manifold pressure pₛ is recognizable.

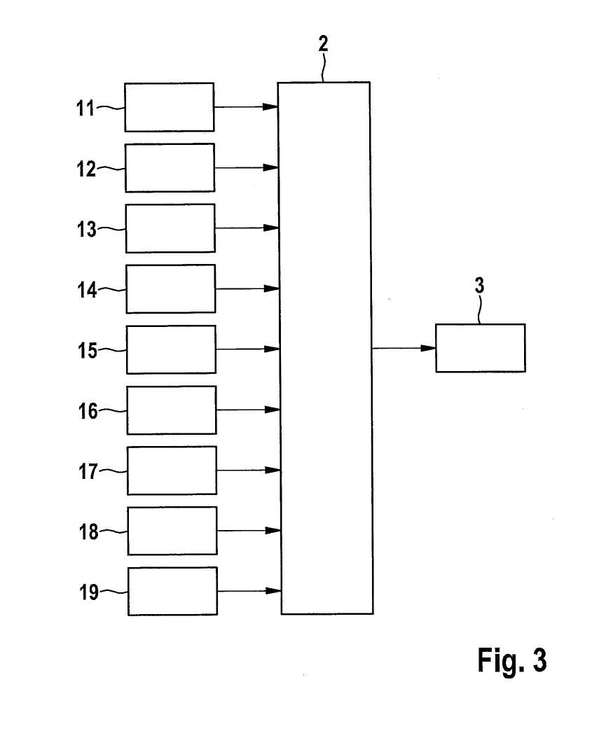

In order to ensure a robust operating mode switchover from SI to HCCI and back, the cylinder charge is determined according to the present invention via a charge model. This is illustrated in FIG. 3. Into this model 2, rotational speed 11 of the internal combustion engine and its intake manifold pressure 12 are incorporated as input variables; this intake manifold pressure may, for example, be ascertained via a pressure sensor or with the aid of an intake manifold model. Furthermore, intake manifold temperature 13 of the internal combustion engine, which may be ascertained with the aid of a temperature sensor, for example, is incorporated into model 2. In addition, exhaust gas mass flow 14 of the internal combustion engine is incorporated into model 2; this exhaust gas mass flow may, for example, be ascertained by measuring the air and the fuel mass flows, by preparing a model for determining the residual gas mass flow, and by determining the exhaust gas mass flow from the air, fuel, and residual gas mass flow. External exhaust gas recirculation (EGR) 15 of the internal combustion engine is also incorporated into model 2 and may, for example, be ascertained with the aid of a measurement or a model. Finally, into charge model 2 are incorporated: a starting variable 16 of a model for internal residual gas determination, a valve control time 17, which may be ascertained by a sensor on the camshaft, for example, a valve lift 18, which may be ascertained by a lift sensor, for example, as well as, to describe the characteristic curve of the operating mode switchover, the operating time, the cycle time, or an input from a switchover strategy, as variable 19. Thus, cylinder charge 3 in the combustion chamber of each individual combustion cycle of the internal combustion engine is determined.

What is claimed is:

1. A method for determining a cylinder charge of an internal combustion engine, comprising:
providing a model;
using, as input variables of the model, a rotational speed of the internal combustion engine, an intake manifold pressure of the internal combustion engine, an intake manifold temperature of the internal combustion engine, an exhaust gas mass flow of the internal combustion engine, an external exhaust gas recirculation of the internal combustion engine, a starting variable of a model for internal residual gas determination, a valve control time, a valve lift, and a variable for a characteristic curve of an operating mode switchover of the internal combustion engine; and
using the model and the input variables to determine the cylinder charge.

2. The method as recited in claim 1, wherein the operating mode switchover takes place from a starting operating mode to a target operating mode, the starting operating mode and the target operating mode are either a spark ignition operating mode or an auto-ignition operating mode, and operating parameters of the starting operating mode are adapted to values required for a target operating mode during a pilot control phase, the operating mode being switched over after the pilot control phase, and the operating parameters being regulated.

3. The method as recited in claim 1, wherein the variable for the characteristic curve of the operating mode switchover is selected from a group including an operating time, a cycle number, and an input from a switchover strategy.

4. The method as recited in claim 1, wherein the model is an empirical model.

5. The method as recited in claim 1, wherein the model is a physically based model.

6. The method as recited in claim 1, wherein the cylinder charge in the combustion chamber of each individual combustion cycle of the internal combustion engine is determined.

7. A computer readable storage medium storing a computer program for determining a cylinder charge of an internal combustion engine, the computer program, when executed by a control unit, causing the control unit to perform the steps of:
providing a model;
using, as input variables of the model, a rotational speed of the internal combustion engine, an intake manifold pressure of the internal combustion engine, an intake manifold temperature of the internal combustion engine, an exhaust gas mass flow of the internal combustion engine, an external exhaust gas recirculation of the internal combustion engine, a starting variable of a model for internal residual gas determination, a valve control time, a valve lift, and a variable for a characteristic curve of an operating mode switchover of the internal combustion engine; and
using the model and the input variable to determine the cylinder charge.

8. A data medium storing a computer program for determining a cylinder charge of an internal combustion engine, the computer program, when executed by a control unit, causing the control unit to perform the steps of:
providing a model;
using, as input variables of the model, a rotational speed of the internal combustion engine, an intake manifold pressure of the internal combustion engine, an intake manifold temperature of the internal combustion engine, an exhaust gas mass flow of the internal combustion engine, an external exhaust gas recirculation of the internal combustion engine, a starting variable of a model for internal residual gas determination, a valve control time, a valve lift, and a variable for a characteristic curve of an operating mode switchover of the internal combustion engine; and
using the model and the input variable to determine the cylinder charge.

9. A control unit for operating an internal combustion engine, the control unit configured to determine the cylinder charge of the internal combustion engine by using a model, the control unit configured to use, as an input variable of the model, a rotational speed of the internal combustion engine, an intake manifold pressure of the internal combustion engine, an intake manifold temperature of the internal combustion engine, an exhaust gas mass flow of the internal combustion engine, an external exhaust gas recirculation, a starting variable of a model for internal residual gas determination, a valve control time, a valve lift, and a variable for the characteristic curve of an operating mode switchover of the internal combustion engine.

10. The control unit as recited in claim 9, wherein the model is an empirical model.
